(19) United States
(12) Patent Application Publication
(10) Pub. No.: US 2002/0066975 A1
(43) Pub. Date: Jun. 6, 2002

(54) Reduction of allergens in latex devices

(75) Inventor: Niels Elvig, Beijing (CN)

Correspondence Address: NOVOZYMES NORTH AMERICA, INC., C/O NOVO NORDISK OF NORTH AMERICA, INC., 405 LEXINGTON AVENUE, SUITE 6400, NEW YORK, NY, 10174, US

(73) Assignee: Novozymes A/S, Bagsvaerd (DK)

(21) Appl. No.: 09/953,696

(22) Filed: Sep. 17, 2001

Related U.S. Application Data
(60) Provisional application No. 60/234,107, filed on Sep. 21, 2000.

(30) Foreign Application Priority Data
Sep. 15, 2000 (DK) PA 2000 01372

(51) Int. Cl. B29B 15/00; B29C 71/00; B29C 71/02; C08L 7/02

(52) U.S. Cl. 264/232; 264/236; 264/344; 523/332

(57) ABSTRACT

The allergens and extractable protein content of a latex device can be reduced by subjecting the un-cured latex device to a pre-cure leaching treatment with a solution containing a protease, followed by curing and a post-cure leaching treatment.

### CROSS-REFERENCE TO RELATED APPLICATIONS

This application claims, under 35 U.S.C. 119, priority of Danish application no. PA 2000 01372, filed Sep. 15, 2000, and benefit of U.S. provisional application No. 60/234,107, filed Sep. 21, 2000, the contents of which are fully incorporated herein by reference.

### FIELD OF THE INVENTION

The invention relates to methods for reducing the amount of latex allergens and extractable protein in latex devices.

### BACKGROUND

Devices made from natural rubber latex generally contain protein (e.g. latex allergens), and this may give rise to a variety of undesirable effects in the finished device, including allergic reactions in devices intended for use in contact with humans or animals.

Halogenation (e.g. chlorination) and other chemical surface treatments have been used to reduce the extractable protein content and the allergenicity of the final product. While effective, this step is difficult to control, environmentally problematic and has the shortcoming of reducing shelf life of the latex device. It would be desirable to provide a latex device free of latex allergens without resorting to the device-deteriorating practices now in vogue.

It is an object of the present invention to provide a rubber latex device with a reduced amount of latex allergens and/or extractable protein.

### SUMMARY OF THE INVENTION

We have found that the allergens and/or extractable protein content of a latex device can be reduced by subjecting the un-cured latex device to a pre-cure leaching treatment with a solution containing a protease, followed by curing and a post-cure leaching treatment.

Accordingly, there is provided a method for reducing the amount of allergens and/or extractable protein in a latex device, comprising subjecting the latex device to the steps of:

a pre-cure leaching treatment with a leaching solution containing a protease;

a curing treatment; and

a post-cure leaching treatment.

In a second aspect, there is provided a method for preparing a latex device, comprising the steps of:

forming the un-cured latex into the desired shape;

pre-cure leaching with a leaching solution containing a protease;

curing;

post-cure leaching; and

recovering the latex device

In a preferred embodiment, the post-cure leaching treatment is done with a leaching solution comprising a salt and/or a surfactant. In another preferred embodiment the method results in a ratio between extractable protein and allergens of at least 1.

In a third aspect, there is provided a latex device obtainable by the method of the invention.

In a further aspect, there is provided a latex device with a ratio between extractable protein and allergens of at least 1. The invention also covers use of the latex device for protection of humans and animals from chemicals, bacteria and virus.

The methods of the invention are applicable to any device made of latex, particularly latex-dipped products, such as latex gloves.

Other advantages of using the methods of the invention include reduced process time and reduced water usage as compared to traditional methods.

### DETAILED DESCRIPTION OF THE INVENTION

Definitions

The protein content in latex devices is commonly expressed in two different ways: as total extractable protein and as protein allergens.

The term “allergens” is to be understood as proteins capable of inducing allergenicity in humans or animals. Allergenicity can be measured as described by Palosuo et al., Allergy, vol. 53 (1) p. 59-67 (1998) in section “IgE-ELISA inhibition”.

The term “extractable protein” is to be understood as protein capable of being extracted from latex. Total extractable protein can be measured, e.g., as described by the American Society for Testing and Materials, ASTM 5712-95; or as described by Rubber Research Institute of Malaysia (RRIM) in Modified Lowry Microassay for Soluble Protein Content of NR Latex Gloves, Malaysian Standard no. MS 1392:1998.

Latex Devices

Latex devices comprise any device made from natural latex or natural/synthetic latex blends, such as devices for protection of humans and animals from chemicals, bacteria and virus, particularly latex products formed by molding and latex products formed by dipping in a liquid latex composition (latex-dipped products), such as thin-walled devices, e.g., surgeons gloves, physicians examining gloves, workers gloves, household gloves, prophylactics, medical catheters, balloons, tubing, condoms, sheeting and the like. The natural latex mentioned above comprise any natural latex obtainable from plants, which can be used for producing the above-mentioned latex devices. Preferably the natural latex is obtainable from the Hevea rubber plant, such as Hevea brasiliensis.

Proteases

The proteases suitable for being incorporated in the pre-cure leaching solution include enzymes classified under the Enzyme Classification number E.C. 3.4 in accordance with the Recommendations (1992) of the International Union of Biochemistry and Molecular Biology (IUBMB).

Examples include proteases selected from those classified under the Enzyme Classification (E.C.) numbers:

3.4.11 (i.e. aminopeptidases), including 3.4.11.5 (Prolyl aminopeptidase), 3.4.11.9 (X-pro aminopeptidase), 3.4.11.10 (Bacterial leucyl aminopeptidase), 3.4.11.12 (Thermophilic aminopeptidase), 3.4.11.15 (Lysyl aminopeptidase), 3.4.11.17 (Tryptophanyl aminopeptidase), 3.4.11.18 (Methionyl aminopeptidase);

3.4.21 (i.e. serine endopeptidases), including 3.4.21.1 (Chymotrypsin), 3.4.21.4 (Trypsin), 3.4.21.25 (Cucumisin), 3.4.21.32 (Brachyurin), 3.4.21.48 (Cerevisin) and 3.4.21.62 (Subtilisin; such as subgroup I-S1 and I-S2 as described by Siezen et al., Protein Engineering, Vol. 4 (7) pp. 719-738 (1991));

3.4.22 (i.e. cysteine endopeptidases), including 3.4.22.2 (Papain), 3.4.22.3 (Ficain), 3.4.22.6 (Chymopapain), 3.4.22.7 (Asclepain), 3.4.22.14 (Actinidain), 3.4.22.30 (Caricain) and 3.4.22.31 (Ananain);

3.4.23 (i.e. aspartic endopeptidases), including 3.4.23.1 (Pepsin A), 3.4.23.18 (Aspergillopepsin I), 3.4.23.20 (Penicillopepsin) and 3.4.23.25 (Saccharopepsin); and

3.4.24 (i.e. metalloendopeptidases), including 3.4.24.28 (Bacillolysin).

Examples of relevant subtilisins comprise subtilisin BPN′, subtilisin amylosacchariticus, subtilisin 168, subtilisin mesentericopeptidase, subtilisin Carlsberg, subtilisin DY, subtilisin 309, subtilisin 147, thermitase, aqualysin, Bacillus PB92 protease, proteinase K, Protease TW7, and Protease TW3.

Specific examples of such readily available commercial proteases include Esperase®, Alcalase®, Neutrase®, Durazym®, Everlase®, Savinase®, Savinase NR®, Kannase®, Pyrase®, Pancreatic Trypsin NOVO (PTN), Bio-Feed Pro, Clear-Lens Pro (all enzymes available from Novo Nordisk A/S). A preferred protease is Savinase NR®.

Examples of other commercial proteases include Maxatase®, Maxacal®, Maxapem®, Opticlean®, Properase®, Purafect®, Purafect OxP®, FN2®, FN3® and FN4® marketed by Genencor International; and BLAP® and BLAP S® marketed by Henkel.

It is to be understood that also protease variants are contemplated as the protease of the invention. Examples of such protease variants are disclosed in EP 130756 (Genentech), EP 214435 (Henkel), WO 87/04461 (Amgen), WO 87/05050 (Genex), EP 251446 (Genencor), EP 260105 (Genencor), Thomas et al., (1985), Nature, 318, p. 375-376, Thomas et al., (1987), J. Mol. Biol., 193, pp. 803-813, Russel et al., (1987), Nature, 328, p. 496-500, WO 88/08028 (Genex), WO 88/08033 (Amgen), WO 89/06279 (Novo Nordisk A/S), WO 91/00345 (Novo Nordisk A/S), EP 525610 (Solvay) and WO 94/02618 (Gist-Brocades N.V.).

The activity of proteases can be determined as described in “Methods of Enzymatic Analysis”, third edition, 1984, Verlag Chemie, Weinheim, vol. 5.

Contemplated proteolytic enzymes include proteases selected from the group of acidic aspartic proteases, cysteine proteases, serine proteases, such as subtilisins, or metallo proteases.

The concentration of the protease in the pre-cure leaching solution is typically in the range of 0.1-2000 mg enzyme protein per liter, preferably 0.5-1000 mg enzyme protein per liter, more preferably 1-500 mg enzyme protein per liter, most preferably 5-250 mg enzyme protein per liter, and in particular 10-100 mg enzyme protein per liter.

Surfactants

The surfactants suitable for being incorporated in the post-cure leaching solution may be non-ionic (including semi-polar), anionic, cationic and/or zwitterionic. The surfactants are preferably anionic or non-ionic. The surfactants are typically present in the post-cure leaching solution at a concentration of from 0.01% to 10% by weight.

When included therein, the post-cure leaching solution will usually contain from about 0.01% to about 10%, preferably about 0.05% to about 5%, and more preferably about 0.1% to about 1% by weight of an anionic surfactant, such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein the post-cure leaching solution will usually contain from about 0.01% to about 10%, preferably about 0.05% to about 5%, and more preferably about 0.1% to about 1% by weight of a non-ionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Salts

The salts suitable for being incorporated in the post-cure leaching solution may be one or more organic or inorganic salts, preferably the salts are soluble in water at a concentration of at least 1 mg/l at a temperature of 50° C.

In an embodiment, the salt is an earth alkali metal salt or an alkali metal salt, such as a sodium, potassium, magnesium or calcium salt. The salt may be a sulphate, a nitrate, a carbonate, a bicarbonate, a phosphate, a halide (such as a chloride, a bromide, or a iodide) a citrate or a combination of two or more of these. Preferably the salt is sodium chloride (NaCl) or potassium chloride (KCl).

In another embodiment, the salt provides the post-cure leaching solution with a modified ionic strength, such as a ionic strength of at least 0.0005, preferably at least 0.001, more preferably at least 0.01, most preferably at least 0.1, and in particular 1.

The salt of the invention may be present in the post-cure leaching solution at a concentration of 0.001% to 10% by weight, preferably 0.001% to 1% by weight, more preferably 0.01% to 1% by weight, and most preferably 0.01% to 0.1% by weight.

Treatments

Production of latex devices include several process steps of which the present invention is mainly concerned with the pre-cure leaching and the post-cure leaching treatment.

The term “leaching” is to be understood as washing or rinsing of the latex device with an aqueous solution (leaching solution). “Pre-cure leaching” is to be understood as a leaching process, which is carried out before the curing process; and “post-cure leaching” is to be understood as a leaching process, which is carried out after the curing process. Pre-cure leaching may be referred to as “wet gel leaching”.

The term “curing” is to be understood as a process in which the latex is converted to a condition in which the elastic properties are conferred, re-established or improved, usually brought about by heating the latex device. Curing is also known as vulcanization.

The post-cure leaching solution may include one or more salts and/or one or more surfactants. Preferably the post-cure leaching solution comprises at least one salt and at least one surfactant. Other conventional additives may also be included, such as polyethylene glycol (PEG), foam inhibitors and polymers like a polyacrylate or polyvinyl pyrrolidone.

Suitable pre-cure and post-cure leaching conditions comprise a duration in the range of 10 seconds to 20 minutes (preferably 30 seconds to 10 minutes, more preferably 1 to 5 minutes), a temperature in the range of 20-100° C. (preferably 30-90° C.), and pH 4-10.5 (preferably pH 6-10, more preferably pH 7-9).

The pre-cure and/or post-cure leaching treatments may be simple immersions in the leaching solution or they may include gentle mechanical stirring.

One or more other enzymes may also be included in the pre-cure and/or post-cure leaching solutions, such as proteases, lipases, cutinases, amylases, carbohydrases, cellulases, pectinases, mannanases, arabinases, galactanases, xylanases, an oxidase, e.g., a laccase, and/or a peroxidase (such as a haloperoxidase).

Suitable curing conditions comprise a duration in the range of 5-60 minutes (preferably 10-30 minutes), and a temperature in the range of 50-250° C. (preferably 100-200° C., more preferably 110-180° C.).

The pre-cure leaching, curing and post-cure leaching of the latex device may be done in a sequential process or with other process steps in between. The process may be a continuous process (on-line) or a batch process (off-line) or a combination thereof.

The treatments described above are typically followed by other process steps, such as treatment of the latex device with talc or starch (starch slurry).

Low allergenic latex devices

As will be understood from the discussion above, the present invention also relates to latex devices per se. Thus, in another aspect, the present invention provides a latex device obtainable by the method comprising the steps of:

forming the un-cured latex into the desired shape;

pre-cure leaching with a leaching solution containing a protease;

curing;

post-cure leaching; and

recovering the latex device.

In a further aspect, the invention provides a latex device wherein the ratio between extractable protein and allergens (as described in the Examples) is at least about 1, preferably at least about 2, more preferably at least about 3, most preferably at least about 5, and in particular at least about 10. When the latex device is a glove, the ratio between extractable protein and allergens mentioned above may apply to the wearer side of the glove, the patient side of the glove, or to both sides.

In an interesting embodiment, the latex device of the invention may contain at east 0.01 (preferably at least 0.05, more preferably at least 0.1, most preferably at east 0.5, and in particular at least 1) micrograms of a protease per gram of latex. In another embodiment, the amount of latex allergen in the latex device is reduced to less than 200 (preferably less than 100, more preferably less than 50, and most preferably less than 10) AU per ml as determined with the analysis method described by Palosuo et al., Allergy, vol. 53 (1) p. 59-67 (1998) in section “IgE-ELISA inhibition”. The amount of extractable protein is reduced to less than 400 (preferably less than 300, more preferably less than 200, and most preferably less than 100) ppm as determined according to Malaysian Standard, MS 1392:1998. When the latex device is a glove, the amount of allergens and/or extractable protein may apply to the wearer side of the glove, the patient side of the glove, or to both sides.

In yet another embodiment, the latex device may have improved mechanical/physical properties, such as improved tear strength (particularly of an aged latex device) and/or improved shelf life, as compared to chlorine treated latex devices. The latex device may contain less than 0.01 micrograms of chlorine per gram of latex. Tear strength may be measured in accordance with ASTM D412:1992, ASTM D573:1998, or ASTM D624:1991; preferably ASTM D573:1998.

Uses

The latex device of the invention is useful for protection of humans and animals from chemicals, bacteria and virus (such as HIV).

The present invention is further described by the following examples, which should not be construed as limiting the scope of the invention.

### EXAMPLES

Chemicals used as buffers and substrates were commercial products of at least reagent grade.

Latex glove definitions

Wear Side:

The inner side of the glove when it is received from the manufacturer, and normally also the side, which is in contact with the user's skin.

Patient Side:

The outer side of the glove when it is received from the manufacturer.

One-Side Latex Allergen (AU) Analysis

This section describes how to analyze the amount of latex allergen from only one side of a latex glove by using a modified version of “IgE-ELISA inhibition” as described by Palosuo et al., Allergy, vol. 53 (1) p. 59-67 (1998).

Extraction of latex allergen from wear side

25 ml of extraction buffer (same extraction buffer as used in the “IgE-ELISA inhibition” procedure) is filled into the glove, the top air is squeezed out, and the glove is tied by a knot in the wrist. The glove is placed on a table at 25° C. (+/−3° C.) and rolled around every 30 minutes. After 150 minutes the buffer in the glove is drained into a 250 ml beaker by cutting a hole in the fingertips of the glove.

Extraction of latex allergen from patient side

Same procedure as “Extraction of latex allergen from wear side”, except that the glove is inverted (inside out) before the extraction buffer is filled into the glove.

Latex allergen analysis

The extraction buffer is analyzed according to “IgE-ELISA inhibition” as described in Palosuo et al., Allergy, vol. 53 (1) p. 59-67 (1998). The results are calculated as latex allergen (AU) per ml extraction buffer.

One-Side Extractable Protein (EP) Analysis

This section describes how to analyze the amount of extractable protein from only one side of a latex glove by using a modified version of Malaysian Standard no. MS 1392:1998.

Extraction of Protein from Wear Side

100 ml of extraction buffer (same extraction buffer as used in the MS 1392:1998 procedure) is filled into the glove, the top air is squeezed out, and the glove is tied by a knot in the wrist. The glove is placed on a table at 25° C. (+/−3° C.) and rolled around every 30 minutes. After 180 minutes the buffer in the glove is drained into a 250 ml beaker by cutting a hole in the fingertips of the glove.

Extraction of Protein from Patient Side

Same procedure as “Extraction of protein from wear side”, except that the glove is inverted (inside out) before the extraction buffer is filled into the glove.

Extractable Protein (EP) Analysis

The extraction buffer is analyzed as described by Rubber Research Institute of Malaysia (RRIM) in Malaysian Standard no. MS 1392:1998. The results are calculated as mg protein per ml extraction buffer, or μg protein per 100 ml extraction buffer.

### Example 1

Pre-cure and Post-cure Leaching of Latex Gloves in an On-line Process

A latex dip glove line was used to produce latex gloves from a conventional latex concentrate. The dipped latex gloves were subjected to a pre-cure-leaching followed by curing and a post-cure leaching. The following process conditions were used:

Pre-cure Leaching

Pre-cure leaching was done in 3400 liters of water at a temperature in the range of 55-66° C. The pre-cure leaching time was 112 seconds.

Curing

Curing (or vulcanizing) was done by heating the glove samples in an oven to 120-130° C. for 11-12 minutes. Curing conditions were not changed during the experiment.

Post-cure Leaching

Post-cure leaching was done in 3400 liters of water at a temperature in the range of 70-85° C. The post-cure leaching time was 90 seconds.

Post-cure leaching was followed by rinsing in 600 liters of clean water for 15 seconds at a temperature in the range of 39-41° C.

Procedure

Pre-cure leaching was done either in water, or in water with 0.17% w/v protease (for details, see table 1). The protease used was Savinase® 16.0 L, Type NR (available from Novo Nordisk A/S, Denmark). The protease was dissolved in the pre-cure leaching solution (no pH adjustment) just before the process started.

Post-cure leaching was done either in water, or in water with a surfactant and/or a salt (for details, see table 1). The surfactant used was a sodium lauryl sulphate surfactant: Surfac SLS/BP (available from Surfachem Ltd., United Kingdom). The salt used was sodium chloride (NaCl) of reagent grade. Both the surfactant and the salt were dissolved in jars and left for 30 minutes before being added to the post-cure leaching solution (no pH adjustment) just before the process started. Glove samples I and IV were not subjected to post-cure leaching. The process was completed by rinsing the gloves in water for 15 seconds at 39-41° C.

The glove samples were analyzed for latex allergen (AU) and extractable protein (EP) as described earlier. Further, the ratios between EP and AU were calculated.

TABLE 1
Experimental conditions:

| | Pre-cure leaching | Post-cure leaching |
|---|---|---|
| Glove sample | 112 seconds | 90 seconds |
| Glove I | 55-60° C. | none |
| | pH 7.5-8.0 | |
| Glove II | 55-60° C. | 70-85° C. |
| | pH 7.5-8.0 | pH 7.5-8.0 |
| Glove III | 55-60° C. | 74-85° C. |
| | pH 7.5-8.0 | pH 8.0 |
| | | 0.19 % w/v surfactant |
| Glove IV | 56-60° C. | none |
| | pH 7.5-8.0 | |
| | 0.17% w/v protease | |
| Glove A | 56-60° C. | 74-85° C. |
| | pH 7.5-8.0 | pH 8.0 |
| | 0.17% w/v protease | 0.19% w/v surfactant |
| Glove B | 56-62° C. | 76-85° C. |
| | pH 8.0 | pH 8.0 |
| | 0.17% w/v protease | 0.19% w/v surfactant |
| | | 0.006% w/v salt |
| Glove C | 56-62° C. | 78-85° C. |
| | pH 8.0 | pH 8.0 |
| | 0.17% w/v protease | 0.29% w/v surfactant |
| | | 0.006% w/v salt |
| Glove D | 56-64° C. | 80-85° C. |
| | pH 8.0 | pH 8.0 |
| | 0.17% w/v protease | 0.29% w/v surfactant |
| | | 0.06% w/v salt |
| Glove E | 56-66° C. | 82-85° C. |
| | pH 8.0 | pH 8.0 |
| | 0.17% w/v protease | 0.39% w/v surfactant |
| | | 0.06% w/v salt |

TABLE 2
Analysis of Extractable Protien (EP):

| | Both-side | Both-side | | |
|---|---|---|---|---|
| | EP analysis | EP analysis | One-side | One-side |
| | ASTM | MS | EP analysis | EP analysis |
| | 5712-95 | 1392:1998 | (Wear) | (Patient) |
| Sample | ppm | ppm | μg/100 ml | μg/100 ml |
| Glove I | 576 | 738 | not tested | not tested |
| Glove II | 154 | 407 | 482 | 1102 |
| Glove III | 101 | 352 | not tested | not tested |
| Glove IV | not tested | 938 | >3333 | not tested |
| Glove A | 154 | 347 | not tested | not tested |
| Glove B | 129 | 300 | 403 | not tested |
| Glove C | 121 | 258 | 421 | 654 |
| Glove D | 102 | 228 | 390 | 574 |
| Glove E | 139 | 215 | 286 | 642 |

Gloves were analyzed at least in duplicate - results are shown as average.

TABLE 3
Analysis of Latex Allergen (AU):

| | Both-side AU | One-side AU | One-side AU |
|---|---|---|---|
| | analysis * | analysis | analysis |
| | (1 g glove/5 ml) | (Wear) | (Patient) |
| Sample | AU/ml | AU/ml | AU/ml |
| Glove I | not tested | >1000 | 489 |
| Glove II | 471 | 154 | 209 |
| Glove IV | not tested | >1000 | 74 |
| Glove C | 131 | not tested | not tested |
| Glove D | 64 | not tested | not tested |
| Glove E | 59 | 9 | 27 |

Gloves were analyzed at least in duplicate - results are shown as average.
* as determined according to Palosuo et al., Allergy, vol. 53 (1) p. 59-67 (1998).

TABLE 4
Calculated ratio between EP and AU (EP/AU):

| | Both-side | One-side analysis | One-side analysis |
|---|---|---|---|
| Sample | analysis * | (Wear) | (Patient) |
| Glove II | 407/471 = 0.9 | 482/154 = 3.1 | 1102/209 = 15.3 |
| Glove E | 215/59 = 3.6 | 286/9 = 31.8 | 642/27 = 23.8 |

* Both-side ER was determined accordingto MS 1392:1998.

1. A method for reducing the amount of allergens and/or extractable protein in a latex, comprising subjecting un-cured latex to:
a) a pre-cure leaching treatment with a leaching solution comprising a protease;
b) a curing treatment; and
c) a post-cure leaching treatment.

2. A method for preparing a latex, comprising the steps of:
a) forming an un-cured latex into a desired shape;
b) pre-cure leaching of the latex with a leaching solution comprising a protease;
c) curing the latex;
d) post-cure leaching of the latex; and
e) recovering the latex.

3. The method of claim 1 or 2, wherein the post-cure leaching is done with a leaching solution containing a surfactant.

4. The method of claim 1 or 2, wherein the post-cure leaching is done with a leaching solution containing a salt.

5. The method of claim 1 or 2, wherein the latex is a latex-dipped product.

6. The method of claim 1 or 2, wherein the latex is a glove.

7. The method of claim 1 or 2, wherein the latex has a ratio between extractable protein and latex allergen of at least about 1.

8. The method of claim 7, wherein the latex device contains at least 0.01 micrograms of a protease per gram of latex.

9. A latex produced by the method of any of claims 1-8.

10. A latex, wherein the ratio between extractable protein and latex allergen is at least about 1, wherein the ratio is calculated as described in Example 1.

11. The latex of claim 10, which further comprises at least 0.01 micrograms of a protease per gram of latex.

12. The latex of claim 10 or 11, wherein the amount of extractable protein is determined as described in Malaysian Standard, MS 1392:1998, and the amount of latex allergen is determined as described by Palosuo et al., Allergy, vol. 53 (1) p. 59-67 (1998) in section “IgE-ELISA inhibition”.

13. The latex of any of claims 10-12, which further comprises less than 0.01 micrograms of chlorine per gram of latex.

14. The latex of any of claims 10-13, wherein the latex has an improved tear strength compared to a chlorine treated latex device when determined in accordance with ASTM D573:1998.

15. Use of the latex device of any of claims 9-14 for protection of humans and animals from chemicals, bacteria and virus.
